(19) United States
(12) Patent Application Publication
(10) Pub. No.: US 2019/0324116 A1
(43) Pub. Date: Oct. 24, 2019

(54) OPERATION SOUND BASED DETERMINATION OF A TOOL POSITION

(71) Applicant: Sony Mobile Communications Inc., Tokyo (JP)

(72) Inventors: Ivar BERGKVIST, Lund (SE); Thomas Fänge, Lund (SE); Peter Isberg, Lund (SE); Hannes Bergkvist, Helsingborg (SE); Mattias Falk, Lund (SE)

(21) Appl. No.: 16/388,475

(22) Filed: Apr. 18, 2019

(30) Foreign Application Priority Data
Apr. 20, 2018 (SE) 1830135-8

(51) Int. Cl. G01S 5/22

(52) U.S. Cl. CPC G01S 5/22

(57) ABSTRACT

For determining a position of a tool at least one sound generated by an operation performed by the tool is detected. Further, the position of the tool is then determined based on a timing of the detected at least one sound generated by the operation performed by the tool.

### CROSS REFERENCE TO RELATED APPLICATION

This U.S. non-provisional patent application claims priority under 35 U.S.C. § 119 to Swedish Patent Application No. 1830135-8, filed on Apr. 20, 2018, the disclosure of which is incorporated herein in its entirety by reference.

### FIELD OF THE INVENTION

The present invention relates to methods for measuring a position of a tool and to corresponding devices and systems.

### BACKGROUND OF THE INVENTION

It is known to perform position measurements on the basis of sound signals. For example, a transmitter of ultrasound signals may be placed on an object, and by detecting these ultrasound signals at different locations, the position of the object can be estimated from timing differences.

However, in some scenarios this approach may suffer from interfering sounds in the environment. For example, ultrasound based position measurements may be used in the industrial field, e.g., in connection with an industrial robot as used for manufacturing of products, as for example described in WO 2017/153008 A1. In such scenarios, there may be a significant amount of background sounds, also in the ultrasound frequency range, which may affect the position measurements on the basis of the ultrasound signals. In fact, such background sounds may originate from a tool itself and thus in many cases cannot be avoided. Furthermore, implementation of this kind of sound based position measurements requires usage of a separate transmitter of ultrasound signals.

Accordingly, there is a need for technologies which overcome the above-mentioned problems and allow for efficiently determining a position of a tool on the basis of sound signals.

### SUMMARY OF THE INVENTION

According to an embodiment, a method of determining a position of a tool comprises detecting at least one sound generated by an operation performed by the tool. Further, the method comprises determining the position of the tool based on a timing of the detected at least one sound. By using the sound generated by the operation performed by the tool as a basis for determining the position of the tool, it can be utilized that sounds produced by operation of a tool often have distinctive characteristics and can thus serve as a basis for position measurements. Furthermore, the sounds produced by operation of the tool then do not constitute a source of noise or disturbances, but are rather positively used as a measurement resource. Still further, usage of a dedicated sound source can be avoided, resulting in relaxed hardware requirements.

According to an embodiment, the method may further comprise determining a timing of the operation performed by the tool and determining the position based on the determined timing of the operation and the timing of the detected at least one sound.

The timing of the operation may be determined based on a signal received from the tool. For example, the timing may be determined based on a signal received from a reference device placed on the tool. In some embodiments, the signal may also comprise a recording of the detected at least one sound, which may for example be used as a sound reference for analyzing the detected at least one sound. Alternatively or in addition, the timing may be determined based on a signal provided to the tool, e.g., based on a command to initiate the operation or some other control signal, or based on a supply signal. Alternatively or in addition, the timing may be determined based on optical monitoring of the tool. For example, the operation may be associated with motion of the tool, and a camera or other optical sensor may be used to detect the motion associated with the tool. According to another example, the operation may be associated with light emission from the tool, e.g., light emitted by a welding arc or welding flame, and a camera or other optical sensor may be used to detect the light emission associated with the operation. In each case, the timing of the operation may be determined in an efficient and precise manner.

According to an embodiment, the method may further comprise detecting the at least one sound by multiple sensors placed at different locations and determining the position based on the detection of the at least one sound by the multiple sensors. Based on the detection of the at least one sound by the multiple sensors placed at different locations, the position may be determined in a precise manner, e.g., using a TDOA (time-difference of arrival) or TOA (time of arrival) method. For example, multiple timings of the at least one sound as detected by the multiple sensors could be determined as timing differences, e.g., propagation delays, and these timing differences could be used as input for a TDOA method to calculate the position of the tool. Further, multiple timings of the at least one sound as detected by the multiple sensors could be determined as absolute times with respect to a time reference defined by the timing of the operation, and these absolute times could be used as input for a TOA method to calculate the position of the tool.

According to a further embodiment, a method of supporting determination of a position of a tool comprises detecting at least one sound generated by an operation performed by the tool and indicating a timing of the detected at least one sound to a device for determination of the position of the tool. The timing of the detected at least one sound may be indicated in relation to a timing of the operation performed by the tool. The indicated timing may thus be used by the device for determining the position of the tool, without requiring a dedicated sound source, resulting in relaxed hardware requirements. The device to which the timing is indicated may for example be configured to utilize the indicated timing as an input for a TDOA method or TOA method to determine the position of the tool.

According to an embodiment, the timing of the detected at least one sound may be indicated in relation to a timing of the operation performed by the tool. The operation performed by the tool may thus be utilized as an intrinsic time reference for the determination of the position of the tool.

Also in the method of supporting determination of the position of the tool, the timing of the operation may be determined based on a signal received from the tool. For example, the timing may be determined based on a signal received from a reference device placed on the tool. In some embodiments, the signal may also comprise a recording of the detected at least one sound, which may for example be used as a sound reference for analyzing the detected at least one sound. Alternatively or in addition, the timing may be determined based on a signal provided to the tool, e.g., based on a command to initiate the operation or some other control signal, or based on a supply signal. Alternatively or in addition, the timing may be determined based on optical monitoring of the tool. For example, the operation may be associated with motion of the tool, and a camera or other optical sensor may be used to detect the motion associated with the tool. According to another example, the operation may be associated with light emission from the tool, e.g., light emitted by a welding arc or welding flame, and a camera or other optical sensor may be used to detect the light emission associated with the operation. In each case, the timing of the operation may be determined in an efficient and precise manner.

According to a further embodiment, a device for determining the position of a tool is provided. The device is configured to detect at least one sound generated by an operation performed by the tool. Further, the device is configured to determine the position of the tool based on a timing of the detected at least one sound.

The device may be configured to perform the above-mentioned method of determining the position of a tool. Accordingly, the device may further be configured to determine a timing of the operation performed by the tool and determine the position based on the timing of the operation and the timing of the detected at least one sound. The device may be configured to determine the timing of the operation based on a signal received from the tool, based on a signal provided to the tool, or based on optical monitoring of the tool. Further, the device may be configured to detect the at least one sound by multiple sensors placed at different locations and to determine the position based on the detection of the at least one sound by the multiple sensors. For example, the device may be configured to determine multiple timings of the at least one sound as detected by the multiple sensors as timing differences, e.g., propagation delays, and to use these multiple timing differences as input for a TDOA method to calculate the position of the tool. Further, the device may be configured to determine multiple timings of the at least one sound as detected by the multiple sensors as absolute times with respect to a time reference defined by the timing of the operation, and to use these absolute times as input for a TOA method to calculate the position of the tool. The device may comprise one or more of the multiple sensors.

According to a further embodiment, a device for supporting determination of the position of a tool is provided. The device is configured to detect at least one sound generated by an operation performed by the tool. Further, the device is configured to indicate a timing of the detected at least one sound to a device for determination of the position of the tool.

The device may be configured to perform the above-mentioned method of supporting determination of the position of a tool. Accordingly, the device may further be configured to indicate the timing of the detected at least one sound in relation to a timing of the operation performed by the tool. The device may be configured to determine the timing of the operation based on a signal received from the tool, based on a signal received from a reference device placed on the tool, based on a signal provided to the tool, and/or based on optical monitoring of the tool.

According to a further embodiment, a system for determining the position of a tool is provided. The system comprises one or more first devices configured detect at least one sound generated by an operation performed by the tool and determine a timing of the detected at least one sound. Further, the system comprises one or more second devices configured to detect a timing of the operation performed by the tool. At least one of the first devices and/or of the second devices may be configured to determine the position of the tool based on the timing of the detected at least one sound and the timing of the operation. Alternatively or in addition, the system may comprise a third device configured to determine the position of the tool based on the timing of the detected at least one sound and the timing of the operation. The first device(s) may each be configured to perform the above method of determining the position of the tool or the above method of supporting determination of the position of the tool. Accordingly, in the system the first device(s) may further be configured to determine the timing of the operation performed by the tool and determine the position based on the timing of the operation and the timing of the detected at least one sound. The timing of the operation determined by the first device(s) may be based on the timing of the operation as mentioned by the second device(s). Further, the first device(s) may be configured to determine the timing of the operation based on a signal received from the tool, based on a signal provided to the tool, or based on optical monitoring of the tool. Further, the first device(s) may be configured to detect the at least one sound by multiple sensors placed at different locations and to determine the position based on the detection of the at least one sound by the multiple sensors. Further, the first device(s) may be configured to indicate the timing of the detected at least one sound to a device for determination of the position of the tool, e.g., to the above mentioned third device. The first device(s) may also be configured to indicate the timing of the detected at least one sound in relation to the timing of the operation performed by the tool. Further, the first device(s) may be configured to determine the timing of the operation based on a signal received from the tool, based on a signal received from a reference device placed on the tool, based on a signal provided to the tool, and/or based on optical monitoring of the tool.

In each of the above methods, devices or systems, the at least one sound may include various kinds of sounds generated by an operation of the tool. For example, the tool may comprise a welding tool, and the at least one sound may comprise a sound generated by a welding operation performed by the welding tool. Alternatively or in addition, the tool may comprise a drilling tool, and the at least one sound may comprise a sound generated by a drilling operation performed by the drilling tool. Alternatively or in addition, the tool may comprise a cutting tool, and the at least one sound may comprise a sound generated by a cutting operation performed by the cutting tool. Alternatively or in addition, the tool may comprise a pneumatic actuator, and the at least one sound may comprise a sound generated by the pneumatic actuator when the tool performs the operation. It was found that these types of sounds, which are intrinsically produced during operation of the tool, often exhibit characteristics which make them well suited for sound based position measurements. In some embodiments, the position of the tool may be determined in terms of a point of interaction of the tool with an object being processed by the tool. For example, the position could be the position of a welding spot or a drilling position. The point of interaction of the tool with the object may be regarded as an anchor point during the operation which allows for determining the position of the tool in such a way that the determined position is not affected by irrelevant movements of the tool. The tool may be a handheld tool or a robotic tool.

The above and further embodiments of the invention will now be described in more detail with reference to the accompanying drawings.

### BRIEF DESCRIPTION OF THE DRAWINGS

FIG. 1A schematically illustrates a scenario in which the position of a handheld tool is determined according to an embodiment of the invention.

FIG. 1B schematically illustrates a scenario in which the position of a tool is determined according to an embodiment of the invention.

FIG. 2 schematically illustrates an example of a positioning system architecture according to an embodiment of the invention.

FIG. 3 schematically illustrates a further example of a positioning system architecture according to an embodiment of the invention.

FIG. 4 schematically illustrates a further example of a positioning system architecture according to an embodiment of the invention.

FIG. 5 schematically illustrates a further example of a positioning system architecture according to an embodiment of the invention.

FIG. 6 schematically illustrates a further example of a positioning system architecture according to an embodiment of the invention.

FIG. 7 shows a flowchart for illustrating a method according to an embodiment of the invention.

FIG. 8 shows a flowchart for illustrating a further method according to an embodiment of the invention.

FIG. 9 schematically illustrates a processor-based implementation of an observer device according to an embodiment of the invention.

FIG. 10 schematically illustrates a processor-based implementation of a reference device according to an embodiment of the invention.

### DETAILED DESCRIPTION

In the following, exemplary embodiments of the invention will be described in more detail. It has to be understood that the following description is given only for the purpose of illustrating the principles of the invention and is not to be taken in a limiting sense. Rather, the scope of the invention is defined only by the appended claims and is not intended to be limited by the exemplary embodiments described hereinafter.

The illustrated embodiments relate to measurement of a position of a tool. The tool may for example be a handheld tool or correspond to or be part of an industrial robot system to be used for assembly or manufacturing of a product. The tool may for example include one or more of the following tools: a welding tool, e.g., for arc welding, gas welding, or ultrasonic welding; a cutting tool, e.g., for arc cutting, gas cutting, milling; a drilling tool; a punching tool; a saw tool; an assembly tool, like a driver or wrench; and a manipulator tool. However, it is noted that other kinds of tools are possible as well. Further, the tool may include other components, e.g., pneumatic or electric actuators. If the tool is a handheld tool, such actuator could be used for driving a part of the tool, e.g., like driving rotation in a pneumatic impact driver or wrench. If the tool is a robotic tool, such actuators may be used for moving the tool to desired positions.

In the illustrated examples, it is assumed that one or more sounds generated by operation of the tool are used as a basis for measuring the position of the tool. Accordingly, rather than using a dedicated sound source for performing sound based positioning, intrinsic sounds produced by the operation of the tool are used as a basis for the position measurement. These sounds will in the following also be referred to as operation sounds. Examples of such sounds are: the sound produced when welding an object with a welding tool, the sound produced when cutting an object with a cutting tool, the sound produced when drilling an object with a drilling tool, the sound produced when punching an object with a punching tool, the sound produced when sawing an object with a saw tool, the sound produced when joining two objects with an assembly tool, and the sound when manipulating an object with a manipulator tool. The sound may at least in part be generated by interaction of the tool with an object that is being processed by the tool, e.g., like a spark sound generated during arc welding, a drilling sound, or a milling sound. In such cases, the measured position of the tool may correspond to a point of interaction of the tool with the object being processed. For example, the position could be the position of a welding spot, a drilling position, a milling position, or the like. The sound may also at least in part be generated by movement of components or fluids within the tool, e.g., like the sound caused by rotation of an electric motor, impact sounds generated for driving rotation in impact driver or wrench, the sound caused by venting of gas in a pneumatic actuator, or the sound caused by ejecting of pressurized gas or liquid from a nozzle. In each case, the operation sound may exhibit distinctive characteristics which allows for identifying the operation sound and using it as a basis for sound based positioning measurements, e.g., based on a TDOA or TOA method. Details of corresponding positioning methods, devices, and systems will be further explained below.

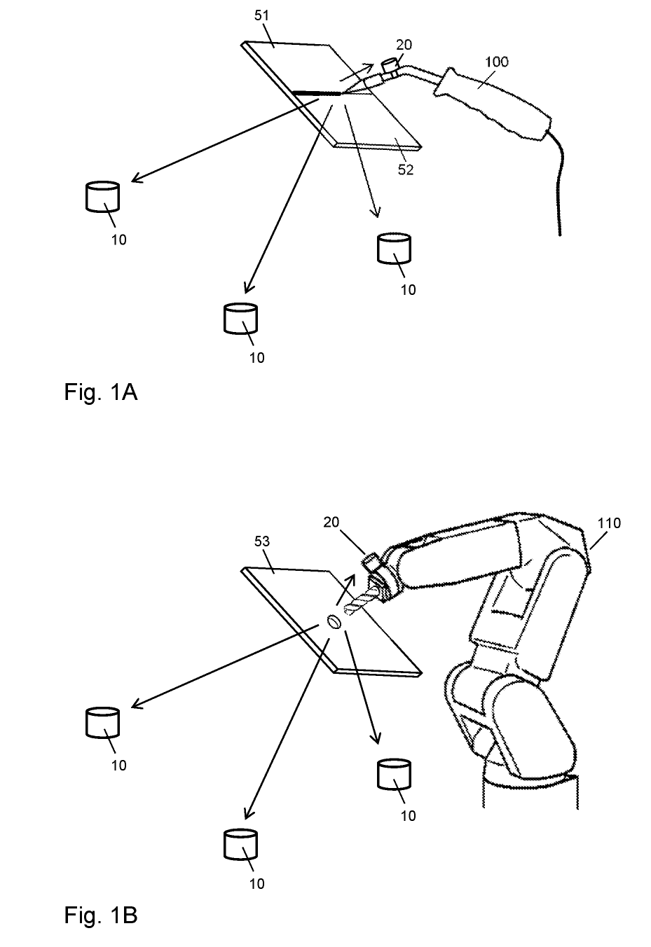

FIG. 1A shows an example of a scenario in which the position of a handheld tool 100 is measured in accordance with the concepts as outlined above. In the illustrated example, the handheld tool 100 is a welding/cutting tool, e.g., a gas welding/cutting tool or an arc welding/cutting tool. In the example of FIG. 1A, the handheld tool 100 is used to form a weld joining two objects 51, 52. The operation of the tool 100 causes distinctive operation sounds, including the sound caused by interaction of the welding tool 100 with the objects 51, 52 being welded. These sounds may be caused by impact of hot gas of a welding flame on the objects 51, 52 or by sparking of a welding arc. Arrows in FIG. 1B schematically illustrate propagation of the operation sound caused by interaction of the drilling tool with the objects 51, 52.

FIG. 1B shows an example of a scenario in which the position of a tool 110 is measured in accordance with the concepts as outlined above. In the illustrated example, the tool 100 includes a drilling tool mounted on a robotic arm, i.e., is a robotic tool. The robotic arm may include pneumatic actuators and/or electric actuators for positioning the drilling tool at a desired position. Further, the robotic tool 110 may include an electric motor for driving rotation of the drilling tool. In the example of FIG. 1B, the drilling tool is used to drill a hole into an object 53. The operation of the robotic tool 110 causes distinctive operation sounds, including the sound caused by interaction of the drilling tool with the object 53, the sound caused by the electric motor driving the rotation of the drilling tool, and the sound caused by one or more other actuators which produce movements of the robotic arm and the drilling tool mounted thereon. These operation sounds typically occur according to a well defined timing which is determined by the control sequence or programming of the robotic tool 110. Arrows in FIG. 1B schematically illustrate propagation of the operation sound caused by interaction of the drilling tool with the object 53.

As further illustrated in FIGS. 1A and 1B, the positioning system includes multiple observer devices 10, which are placed at different locations in the vicinity of the tool 100, 110, and a reference device 20 which is mounted on the tool 100, 110. The observer devices 10 and the reference device 20 detect the operation sound of the tool 100, 110. The detected operation sound is used to determine a timing of the operation sound as detected by each of the different observer devices 10 in relation to a timing of the operation of the tool 100, 110 which caused the operation sound. As will be further explained below, the reference device 20 may help to determine the timing of the operation of the tool 100, 110 which caused the operation sound and may also help to identify the operation sound at the observer devices 10. In the examples of FIGS. 1A and 1B, the number of the observer devices 10 is three, which may allow for determining the position of the tool 100, 110 in three dimensions. However, it is noted that a lower number of the observer devices 10 could be used as well, e.g., if the position of the tool 100, 110 needs to be determined in only two dimensions or only in terms of a linear distance, i.e., in one dimension. Further, a higher number of the observer devices 10 could be used to enhance precision of the measurements by statistic analysis.

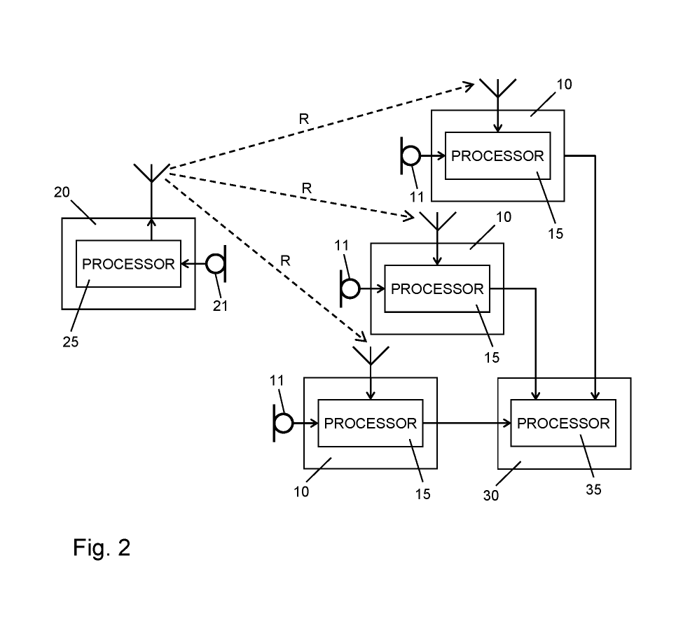

FIG. 2 schematically illustrates an example of an architecture of the positioning system. In the architecture of FIG. 2, the positioning system includes the observer devices 10, the reference device 20, and a locator device 30. In the example of FIG. 2, each of the observer devices 10 includes a microphone 11 or similar sensor allowing for detecting the operation sound. Similarly, also the reference device 20 includes a microphone 21 or similar sensor allowing for detecting the operation sound.

As further illustrated, the reference device 20 includes a processor 25 which processes the detected operation sound and generates a reference signal R which is transmitted as a radio signal to the observer devices 10. The reference signal R may be used to provide the observer devices 10 with a timing reference. In particular, the reference signal R may indicate the timing of the operation that causes the operation sound.

In the example of FIG. 2, the reference device 20 may determine the timing of the operation on the basis of the operation sound as detected by the microphone 21 of the reference device 20. Since the reference device 20 is placed on the tool 100, 110, like illustrated in FIG. 1A or 1B, the propagation delay of the operation sound to the reference device 20 is small as compared to the propagation delays of the operation sound to the observer devices 10. Further, since the reference device 20 is placed on the tool 100, 110, the propagation delay of the operation sound to the reference device 20 is not variable and may thus be easily taken into account during calculation of the position of the tool 100, 110, e.g., as a preconfigured parameter. For example, the timing of the operation may be estimated as corresponding to the timing of the operation sound as detected by the microphone 21 of the reference device 20, shifted by a fixed delay corresponding to the propagation delay of the operation sound to the reference device 20. Accordingly, the timing of the operation sound as detected at the reference device 20 may be used as an estimate for the timing of the operation or as basis for obtaining such estimate. Here, it is noted that in some cases the operation sound may be short sound of 1 ms or less duration and be thus be used itself to determine the timing in terms of the time instance when the operation sound is detected. This may for example be the case if the operation sound includes a spark sound produced during welding. In other cases, the operation sound may be a more complex longer sound. In this case, one or more features within the operation sound may be used to determine the timing in terms of one or more characteristic features occurring during the operation sound, e.g., a sharp onset of sound and/or a sharp cutoff of sound. Such features may also occur repetitively in the operation sound and may be used to determine the timing in terms of a phase value. Further, correlation analysis of the operation sound with respect to a reference sound could be used to determine the timing in terms of a time instance or phase value.

The observer devices 10 detect the operation sound by the microphones 11. The observer devices 10 each include a processor 15 which processes the detected operation sound to determine a timing of the operation sound as detected by the respective observer device 10. This is accomplished in relation to the timing of the operation indicated by the reference signal R received by the observer device 10. Due to the different locations of the observer devices and correspondingly differing propagation delays of the operation sound to the observer devices 10, the determined timing may differ between the observer devices 10. The different timings of the at least one sound as detected by the multiple sensors could be determined as timing differences, e.g., as propagation delays, by using the determined timing of the operation for estimating the time when the at least one operation sound was generated. Further, the different timings of the at least one sound as detected by the multiple sensors could be determined as absolute times with respect to a time reference defined by the timing of the operation.

As further illustrated, the observer devices 10 indicate the respectively determined timing of the detected operation sound to the locator device 30. The locator device 30 includes a processor 35 which processes the received timings in order to calculate the position of the tool 100, 110, e.g., based on a TDOA or TOA method.

In the architecture of FIG. 2, the reference device 20 may further use the microphone 21 to record the operation sound. The reference signal R may then further be used for conveying the recording of the operation sound to the observer devices 10. The recording of the operation sound may be used by the observer devices 10 to recognize the operation sound, e.g., by using the recording of the operation sound as a basis for pattern matching. The recording of the detected operation sound could also explicitly or implicitly indicate the timing of the operation sound as detected by the reference device 20, e.g., by conveying the recording of the operation sound in realtime or providing the recording with a time stamp. The recording may also be used as a reference sound for determining the timing of the operation sound as detected by the observer device 10 by a correlation analysis. In other implementations, recognizing the operation sound may also be based on a previously prepared recording or a reference simulation of the operation sound which is stored in the observer devices 10 and/or the reference device 20.

In the architecture of FIG. 2, utilizing detection of the operation sound by the reference device 20 as a basis for determining the timing of the operation that caused the operation sound allows for determining the timing of the operation in an efficient manner, without requiring modifications of the tool 100, 110. Accordingly, the architecture of FIG. 2 facilitates retrofitting the positioning system to an existing tool. Furthermore, the reference device 20 may use a similar hardware basis as the observer devices 10, which may help to reduce development and production costs. However, it is noted that other ways of determining the timing of the operation causing the operation sound could be used as well. For example, in addition as an alternative to using the microphone 21 to detect the operation sound caused by the operation, the reference device 20 could be provided with one or more other sensors which allow for monitoring the operation of the tool, e.g., one or more optical sensors like a camera, an accelerometer which allows for monitoring vibration or other movements of the tool 100, 110, or an electrical sensor which allows for monitoring an electric supply of the tool 100, 110.

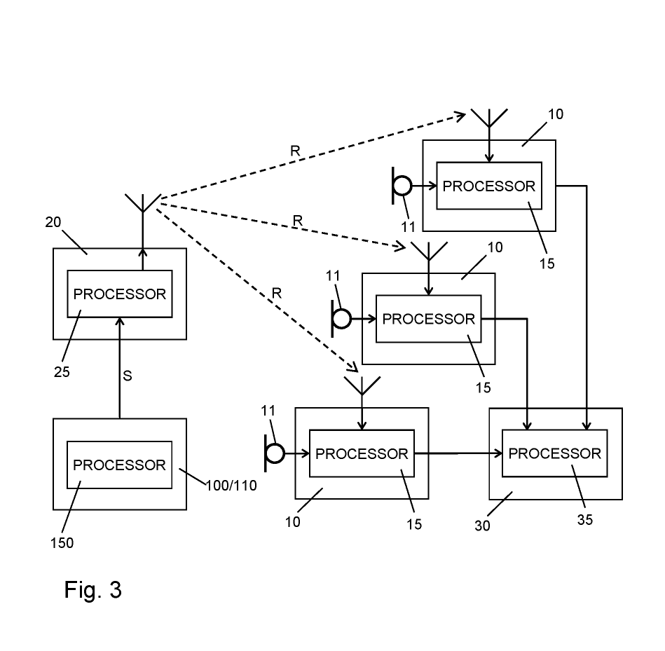

FIG. 3 schematically illustrates a further example of an architecture of the positioning system. In the architecture of FIG. 3, the positioning system includes the observer devices 10, the reference device 20, and a locator device 30. In the example of FIG. 3, each of the observer devices 10 includes a microphone 11 or similar sensor allowing for detecting the operation sound. However, as compared to the previously described examples, the reference device 20 determines the timing of the operation on the basis of a signal S from the tool 100, 110. Accordingly, the tool 100, 110 is provided with a signal interface to the reference device 20. As further illustrated, the tool 100, 110 may be provided with a processor 150 configured to control generation of the signal S. The signal S may for example be an indicator signal which is generated in realtime when the tool 100, 110 starts its operation. Alternatively, the signal S could indicate beforehand the time when the tool 100, 110 will start its operation. The signal S could also be derived from a parameter available for some other purpose at an output interface of the tool 100, 110, e.g., a parameter indicating the present rotation frequency of the drilling tool or a parameter indicating a welding current.

In the architecture of FIG. 3, the reference device 20 includes a processor 25 which processes the signal S from the tool 100, 110 and generates a reference signal R which is transmitted as a radio signal to the observer devices 10. The reference signal R may be used to provide the observer devices 10 with a timing reference. In particular, the reference signal R may indicate the timing of the operation that causes the operation sound. In the example of FIG. 3, the reference device 20 may determine this timing of the operation from the signal S provided by the tool 100, 110.

The observer devices 10 detect the operation sound by the microphones 11. The observer devices 10 each include a processor 15 which processes the detected operation sound to determine a timing of the operation sound as detected by the respective observer device 10. This is accomplished in relation to the timing of the operation indicated by the reference signal R received by the observer device 10. Due to the different locations of the observer devices and correspondingly differing propagation delays of the operation sound to the observer devices 10, the determined timing may differ between the observer devices 10. The different timings of the at least one sound as detected by the multiple sensors could be determined as timing differences, e.g., as propagation delays, by using the determined timing of the operation for estimating the time when the at least one operation sound was generated. Further, the different timings of the at least one sound as detected by the multiple sensors could be determined as absolute times with respect to a time reference defined by the timing of the operation.

In the architecture of FIG. 3, recognizing the operation sound by the observer devices 10 may be based on a previously prepared recording or a reference simulation of the operation sound which is stored in the observer devices 10 and/or the reference device 20.

As further illustrated, the observer devices 10 indicate the respectively determined timing of the detected operation sound to the locator device 30. The locator device 30 includes a processor 35 which processes the received timings in order to calculate the position of the tool 100, 110, e.g., based on a TDOA method or a TOA method.

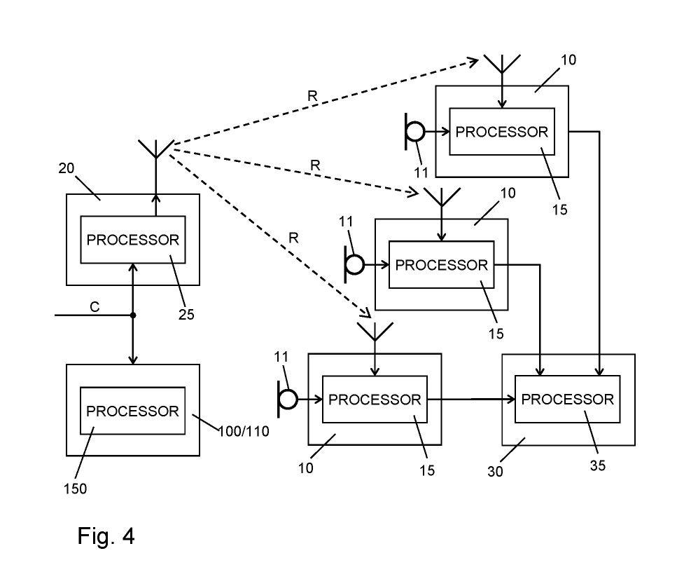

FIG. 4 schematically illustrates a further example of an architecture of the positioning system. In the architecture of FIG. 4, the positioning system includes the observer devices 10, the reference device 20, and a locator device 30. In the example of FIG. 4, each of the observer devices 10 includes a microphone 11 or similar sensor allowing for detecting the operation sound. However, as compared to the previously described examples, the reference device 20 determines the timing of the operation on the basis of a signal provided to the tool 100, e.g., a control signal or a supply signal. In the example of FIG. 4, the tool 100 may be provided with a signal interface to receive an external control signal C, and this external control signal C may also be provided to the reference device 20. As further illustrated, the tool 100 may be provided with a processor 150 configured to interpret the control signal C. The control signal C may for example be a trigger signal which triggers the tool 100 to start its operation. Alternatively, the control signal C could indicate commands to be executed by the processor 150 to control operations of the tool 100, e.g., programming information, from which also the timing of the operation that causes the operation sound can be derived.

In the architecture of FIG. 4, the reference device 20 includes a processor 25 which monitors the control signal C provided to the tool 100 and generates a reference signal R which is transmitted as a radio signal to the observer devices 10. The reference signal R may be used to provide the observer devices 10 with a timing reference. In particular, the reference signal R may indicate the timing of the operation that causes the operation sound. In the example of FIG. 4, the reference device 20 may determine this timing of the operation from the control signal C provided to the tool 100. A supply signal could be monitored in a similar manner to derive the timing of the operation.

The observer devices 10 detect the operation sound by the microphones 11. The observer devices 10 each include a processor 15 which processes the detected operation sound to determine a timing of the operation sound as detected by the respective observer device 10. This is accomplished in relation to the timing of the operation indicated by the reference signal R received by the observer device 10. Due to the different locations of the observer devices and correspondingly differing propagation delays of the operation sound to the observer devices 10, the determined timing may differ between the observer devices 10. The different timings of the at least one sound as detected by the multiple sensors could be determined as timing differences, e.g., as propagation delays, by using the determined timing of the operation for estimating the time when the at least one operation sound was generated. Further, the different timings of the at least one sound as detected by the multiple sensors could be determined as absolute times with respect to a time reference defined by the timing of the operation.

Also in the architecture of FIG. 4, recognizing the operation sound by the observer devices 10 may be based on a previously prepared recording or a reference simulation of the operation sound which is stored in the observer devices 10 and/or the reference device 20.

As further illustrated, the observer devices 10 indicate the respectively determined timing of the detected operation sound to the locator device 30. The locator device 30 includes a processor 35 which processes the received timings in order to calculate the position of the tool 100, e.g., based on a TDOA method or a TOA method.

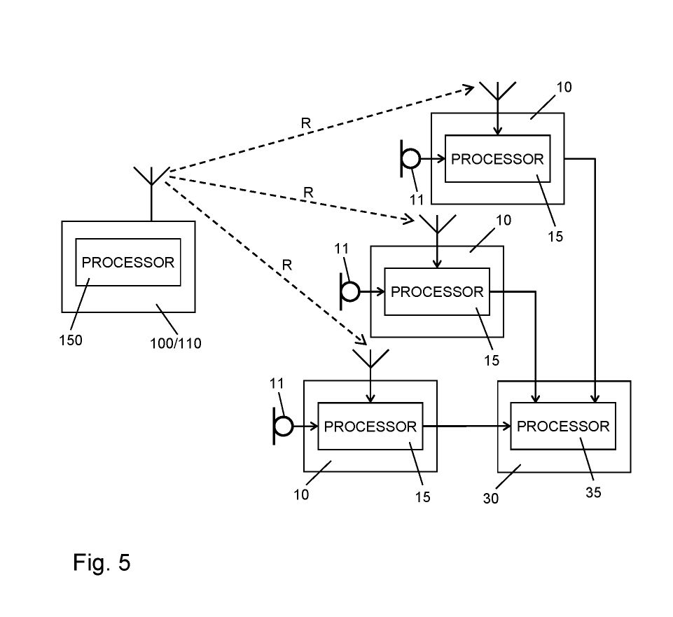

FIG. 5 schematically illustrates a further example of an architecture of the positioning system. In the architecture of FIG. 5, the positioning system includes the observer devices 10 and a locator device 30. In the example of FIG. 5, each of the observer devices 10 includes a microphone 11 or similar sensor allowing for detecting the operation sound. However, as compared to the previously described examples, the tool 100, 110 itself indicates the timing of the operation that causes the operation sound to the observer devices 10. Accordingly, the reference device 20 may be omitted in the architecture of FIG. 5.

In the architecture of FIG. 5, the tool 100, 110 includes a processor 150 which is configured to generate a reference signal R which is transmitted as a radio signal to the observer devices 10. The reference signal R may be used to provide the observer devices 10 with a timing reference. In particular, the reference signal R may indicate the timing of the operation that causes the operation sound. In the architecture of FIG. 5 the processor 150 may derive the reference signal R directly from control processes of the tool 100.

The observer devices 10 detect the operation sound by the microphones 11. The observer devices 10 each include a processor 15 which processes the detected operation sound to determine a timing of the operation sound as detected by the respective observer device 10. This is accomplished in relation to the timing of the operation indicated by the reference signal R received by the observer device 10. Due to the different locations of the observer devices and correspondingly differing propagation delays of the operation sound to the observer devices 10, the determined timing may differ between the observer devices 10. The different timings of the at least one sound as detected by the multiple sensors could be determined as timing differences, e.g., as propagation delays, by using the determined timing of the operation for estimating the time when the at least one operation sound was generated. Further, the different timings of the at least one sound as detected by the multiple sensors could be determined as absolute times with respect to a time reference defined by the timing of the operation.

Also in the architecture of FIG. 5, recognizing the operation sound by the observer devices 10 may be based on a previously prepared recording or a reference simulation of the operation sound which is stored in the observer devices 10.

As further illustrated, the observer devices 10 indicate the respectively determined timing of the detected operation sound to the locator device 30. The locator device 30 includes a processor 35 which processes the received timings in order to calculate the position of the tool 100, 110, e.g., based on a TDOA method or a TOA method.

In the examples of FIGS. 2 to 5, the reference signal R is a radio signal. However, other ways of transmitting the reference signal R could be used as well, e.g., wire based electric signals, cable based optical signals, or wireless optical signals. In each case, the electromagnetic or electric transmission of the reference signal R ensures that a propagation of the reference signal R from the reference device 20 to the observer devices 20 is negligible as compared to propagation delays of the operation sound to the observer devices 10.

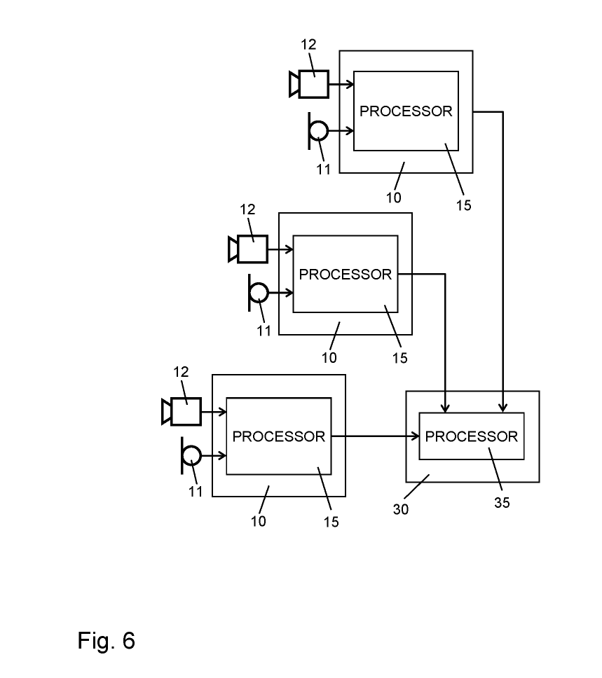

FIG. 6 schematically illustrates a further example of an architecture of the positioning system. In the architecture of FIG. 6, the positioning system includes the observer devices 10 and a locator device 30. In the example of FIG. 6, each of the observer devices 10 includes a microphone 11 or similar sensor allowing for detecting the operation sound. As compared to the previously described examples, the observer devices 10 also detect the timing of the operation that causes the operation sound. Accordingly, the reference device 20 may be omitted in the architecture of FIG. 6. In the illustrated example, the observer devices 10 each include an optical sensor 12 for monitoring the tool 100, 110. Further, the observer devices 10 each include a processor 15.

The optical sensors 12 may include a camera which can detect motion associated with the operation. By detecting the motion, the processor 15 can derive the timing of the operation that causes the operation sound. Alternatively or in addition, the optical sensors 12 may be used by the processor 15 to detect light emission associated with the operation, e.g., light from a welding arc or flame. Since the detection of the motion or light emission is based on optical monitoring, the delay associated with the detection at the observer device 10 is negligible as compared to propagation delays of the operation sound to the observer device 10. Accordingly, the optical detection of the motion or light emission can be used to provide an accurate timing reference for the detection of the operation sound by the observer devices 10.

The observer devices 10 detect the operation sound by the microphones 11. The processor 15 processes the detected operation sound to determine a timing of the operation sound as detected by the respective observer device 10. This is accomplished in relation to the timing of the operation as detected by the processor 15. Due to the different locations of the observer devices and correspondingly differing propagation delays of the operation sound to the observer devices 10, the determined timing may differ between the observer devices 10. The different timings of the at least one sound as detected by the multiple sensors could be determined as timing differences, e.g., as propagation delays, by using the determined timing of the operation for estimating the time when the at least one operation sound was generated. Further, the different timings of the at least one sound as detected by the multiple sensors could be determined as absolute times with respect to a time reference defined by the timing of the operation.

Also in the architecture of FIG. 6, recognizing the operation sound by the observer devices 10 may be based on a previously prepared recording or a reference simulation of the operation sound which is stored in the observer devices 10.

As further illustrated, the observer devices 10 indicate the respectively determined timing of the detected operation sound to the locator device 30. The locator device 30 includes a processor 35 which processes the received timings in order to calculate the position of the tool 100, 110, e.g., based on a TDOA method or a TOA method.

It is noted that while in the architecture of FIG. 6 each of the observer devices 10 also performs optical monitoring of the tool 100, 110 in order to determine the timing of the operation that causes the operation sound, alternative implementations could be based on using only one of the observer devices 10 to determine the timing of the operation. This observer device 10 could then indicate the determined timing of the operation to the other observer devices 10, e.g., by transmitting a reference signal similar to the reference signal R in the examples of FIGS. 2 to 5.

It is also noted that while FIGS. 2 to 6 illustrate the locator device 30 as being implemented as a separate component of the positioning system, it would also be possible to integrate the functionalities of the locator device 30 in one or more of the observer devices 10 or in the reference device 20. For example, when integrating the functionalities of the locator device 30 in one of the observer devices 10, this observer device 10 could receive the timings of the operation sound as determined by the other observer devices 10 and use the timing of the operation sound as determined by the observer device 10 itself together with the timings received from the other observer devices 10 to calculate the position of the tool 100, 110, e.g., based on a TDOA method or a TOA method. The required processing could then be accomplished by the processor 15 of the observer device 10. When integrating the functionalities of the locator device 30 in the reference device 10, the reference device 10 could receive the timings of the operation sound as determined by the observer devices 10, e.g., on a back-channel of a radio link used for transmission of the reference signal R. The reference device 20 may then use the timings received from the observer devices 10 to calculate the position of the tool 100, 110, e.g., based on a TDOA method or a TOA method. The required processing could then be accomplished by the processor 25 of the reference device 20. Further, rather than implementing the determination of the timings at the observer devices 10 or the reference device 20, the timings could also be determined at the locator device 30, based on recordings of the at least one operation sound as provided by the observer devices 10 and optionally also by the reference device 20.

Further, it is noted that in the above-described examples the detection of the operation sound may be triggered in various ways. For example, self-triggering of sound detection could be used. This may for example involve constantly monitoring environmental sound by the microphones 11, 21 and triggering further processing of the sound in response to detecting certain characteristics in the monitored environmental sound, e.g., in response to the environmental sound exceeding a certain intensity level. Further, various kinds of inputs to the observer device 10 to the reference device 20 could be used for triggering the detection of the operation sound. By way of example, the case of the observer devices 10 the reference signal R could also be used for triggering the detection of the operation sound. In the case of the reference device 20 a control signal from the tool 100, 110, e.g., like the above-mentioned signal S, could be used for triggering the detection of the operation sound. Further, the detection of the operation sound could also be triggered by various others sensors of the observer devices 10 or the reference device 20, e.g., an optical sensor for monitoring motion or light emission from the tool 100, 110 or an electrical sensor for monitoring a power supply of the tool 100, 110. By way of example, in the scenario of FIG. 6, the optical sensors 12 could detect motion of the tool 104 light emission from the tool 100, 110, and the detected motion or light emission could be used to trigger detection of the operation sound by the microphones 11.

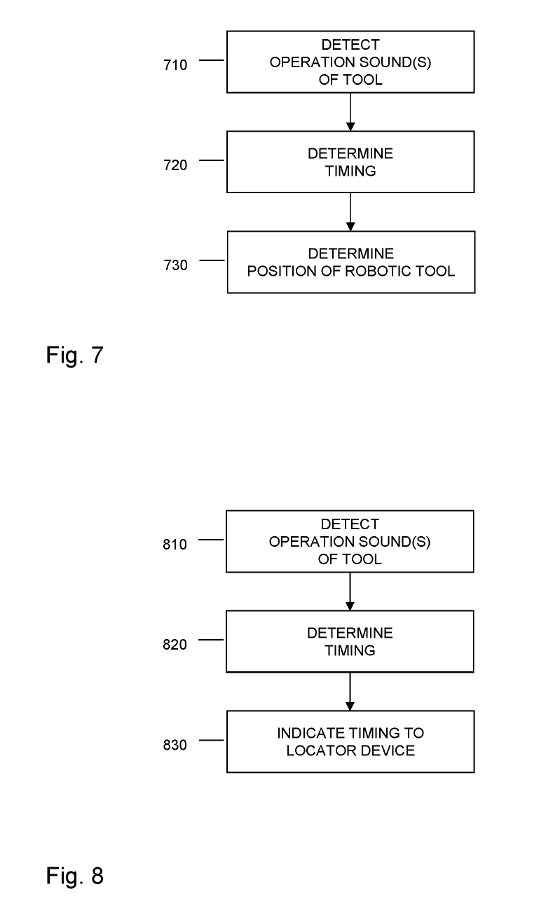

FIG. 7 shows a flowchart illustrating a method which may be used for determining the position of a tool according to the concepts as described above. The tool may include one or more of: a welding tool, e.g., for arc welding, gas welding, or ultrasonic welding; a cutting tool, e.g., for arc cutting, gas cutting, milling; a drilling tool; a punching tool; a saw tool; an assembly tool; a manipulator tool, or the like. The tool may for example correspond to the above-mentioned handheld tool 100 or to the above-mentioned robotic tool 110. The method may for example be implemented by a device like one of the above-mentioned observer devices 10 or by the above-mentioned reference device 20, which further incorporates the functionalities of the above-mentioned locator device 30. If a processor based implementation of the device is utilized, at least a part of the steps of the method may be performed and/or controlled by one or more processors of the device. Further, the method may be implemented by a positioning system including one or more of the above-mentioned observer devices 10 and the above-mentioned reference device 20. Further, the method may be implemented by a positioning system including one or more of the above-mentioned observer devices 10 and the tool 100, 110 acting as a reference device, like in the above-mentioned architecture of FIG. 5.

At step 710, at least one operation sound of the tool is detected. This may for example involve detection of the at least one operation sound by a device like one of the above-mentioned observer devices 10 and/or detection of the at least one operation sound by a device like the above-mentioned reference device 20. The at least one operation sound may be detected by a microphone or similar sensor of the device. In some scenarios, the at least one operation sound may be detected by multiple sensors placed at different locations, e.g., like the above-mentioned microphones 11, 21.

The at least one operation sound may include various kinds of sounds generated by an operation of the tool. For example, the tool may include a welding tool, and the at least one sound may include a sound generated by a welding operation performed by the welding tool. Alternatively or in addition, the tool may include a drilling tool, and the at least one sound may include a sound generated by a drilling operation performed by the drilling tool. Alternatively or in addition, the tool may include a cutting tool, and the at least one sound may include a sound generated by a cutting operation performed by the cutting tool. Alternatively or in addition, the tool may comprise a pneumatic actuator, and the at least one sound may comprise a sound generated by the pneumatic actuator when the tool performs the operation. During the operation, the pneumatic actuator may for example move the tool or a part thereof. The tool may be a handheld tool or a robotic tool.

At step 720, a timing of the operation causing the operation sound may be determined. The timing of the operation may for example be determined in terms of a time instance, e.g., defined by starting of the operation or some other point of time related to the operation. Such time instance may also be defined by a stage of the operation which produces a distinct characteristic of the operation sound, e.g., an sharp onset of sound or a sharp cutoff of sound. The timing of the operation can also be determined in terms of multiple time instances, e.g., defined by starting of the operation, ending of the operation, and/or a stage of the operation producing a distinct characteristic of the operation sound. In some scenarios, the operation may also have a periodic character resulting in a periodically occurring characteristic of the operation sound. For example, this may be the case if the tool includes one or more rotating components. In such cases, the timing may also be determined in terms of a phase value of defined by the periodic character of the operation.

In some scenarios, the timing of the operation may be determined based on a signal received from the tool. An example of such scenarios is explained in connection with FIG. 5, where the observer devices 10 determine the timing of the operation based on the reference signal R provided by the tool 100, 110.

In some scenarios, the timing of the operation may be determined based on a signal received from a reference device placed on the tool. Examples of such scenarios are explained in connection with FIGS. 2, 3, and 4, where the observer devices 10 determine the timing of the operation based on the reference signal R provided by the reference device 20 placed on the tool 100, 110.

In some scenarios, the signal which is used to determine the timing of the operation may also include a recording of the detected at least one operation sound. An example of such scenarios is explained in connection with FIG. 2, where the reference device 20 uses the reference signal R to transmit a recording of the operation sound as detected by the microphone 21 of the reference device 20 to the observer devices 10. In such scenario, the recording of the detected sound may for example be used for recognizing the operation sound(s).

In some scenarios, the timing of the operation may be determined based on a signal provided to the tool, e.g., a control signal or a supply signal. An example of such scenarios is explained in connection with FIG. 4, where the reference device 20 generates the reference signal R based on the control signal C provided to the tool 100, 110, and the observer devices 10 determine the timing of the operation based on the reference signal R generated based on the control signal C.

In some scenarios, the timing of the operation may be determined based on optical monitoring of the tool. An example of such scenarios is explained in connection with FIG. 6, where the observer devices 10 utilize the optical sensors 12 to monitor the tool 100, 110 to determine the timing of the operation performed by the tool 100, 110.

At step 730, the position of the tool is determined based on the timing of the timing of the at least one operation sound detected at step 710. This may for example involve calculating a propagation delay of the at least one operation sound. If the at least one operation sound is detected by multiple sensors placed and different locations, the position may for example be determined based on a TDOA method or a TOA method.

In some scenarios, the position may also be determined based on the timing of the operation determined at step 720 and the timing of the at least one operation sound detected at step 710. In this case, the timing of the operation may be used as a time reference, e.g., for calculating a propagation delay of the detected at least one operation sound. The position of the tool may be determined in terms of a point of interaction of the tool with an object being processed by the tool. For example, in the scenario of FIG. 1A the determined position could be the position of the welding spot, and in the scenario of FIG. 1B the determined position could be the position of the hole being drilled. In such scenarios, the determined position may inherently take into account that there may be movements of the tool while the operation is performed, e.g., due to shortening of a welding pin used in the welding process of FIG. 1A, but the relevant position which needs to be determined, e.g., the welding spot, is not affected by these movements. In other words, the point of interaction of the tool with the object may be regarded as an anchor point during the operation which allows for determining the position of the tool in such a way that irrelevant movements of the tool are filtered out.

FIG. 8 shows a flowchart illustrating a method which may be used for supporting determination of the position of a tool according to the concepts as described above. The tool may include one or more of: a welding tool, e.g., for arc welding, gas welding, or ultrasonic welding; a cutting tool, e.g., for arc cutting, gas cutting, milling; a drilling tool; a punching tool; a saw tool; an assembly tool; a manipulator tool, or the like. The tool may for example correspond to the above-mentioned handheld tool 100 or to the above-mentioned robotic tool 110. The method may for example be implemented by a device like one of the above-mentioned observer devices 10, when supporting with the separate locator device 30, or by the above-mentioned reference device 20, when supporting the observer devices 10. If a processor based implementation of the device is utilized, at least a part of the steps of the method may be performed and/or controlled by one or more processors of the device. Further, the method may be implemented by a positioning system including one or more of the above-mentioned observer devices 10 and the above-mentioned reference device 20. Further, the method may be implemented by a positioning system including one or more of the above-mentioned observer devices 10 and the tool 100, 110 acting as a reference device, like in the above-mentioned architecture of FIG. 5.

At step 810, at least one operation sound of the tool is detected. This may for example involve detection of the at least one operation sound by a device like one of the above-mentioned observer devices 10 and/or detection of the at least one operation sound by a device like the above-mentioned reference device 20. The at least one operation sound may be detected by a microphone or similar sensor of the device. In some scenarios, the at least one operation sound may be detected by multiple sensors placed at different locations, e.g., like the above-mentioned microphones 11, 21.

The at least one operation sound may include various kinds of sounds generated by an operation of the tool. For example, the tool may include a welding tool, and the at least one sound may include a sound generated by a welding operation performed by the welding tool. Alternatively or in addition, the tool may include a drilling tool, and the at least one sound may include a sound generated by a drilling operation performed by the drilling tool. Alternatively or in addition, the tool may include a cutting tool, and the at least one sound may include a sound generated by a cutting operation performed by the cutting tool. Alternatively or in addition, the tool may comprise a pneumatic actuator, and the at least one sound may comprise a sound generated by the pneumatic actuator when the tool performs the operation. During the operation, the pneumatic actuator may for example move the tool or a part thereof. The tool may be a handheld tool or a robotic tool.

At step 820, a timing of the operation causing the operation sound may be determined. The timing of the operation may for example be determined in terms of a time instance, e.g., defined by starting of the operation or some other point of time related to the operation. Such time instance may also be defined by a stage of the operation which produce a distinct characteristic of the operation sound, e.g., an sharp onset of sound or a sharp cutoff of sound. The timing of the operation can also be determined in terms of multiple time instances, e.g., defined by starting of the operation, ending of the operation, and/or a stage of the operation producing a distinct characteristic of the operation sound. In some scenarios, the operation may also have a periodic character resulting in a periodically occurring characteristic of the operation sound. For example, this may be the case if the tool includes one or more rotating components. In such cases, the timing may also be determined in terms of a phase value of defined by the periodic character of the operation.

In some scenarios, the timing of the operation may be determined based on a signal received from the tool. An example of such scenarios is explained in connection with FIG. 5, where the observer devices 10 determine the timing of the operation based on the reference signal R provided by the tool 100, 110.

In some scenarios, the timing of the operation may be determined based on a signal received from a reference device placed on the tool. Examples of such scenarios are explained in connection with FIGS. 2, 3, and 4, where the observer devices 10 determine the timing of the operation based on the reference signal R provided by the reference device 20 placed on the tool 100, 110.

In some scenarios, the signal which is used to determine the timing of the operation may also include a recording of the detected at least one operation sound. An example of such scenarios is explained in connection with FIG. 2, where the reference device 20 uses the reference signal R to transmit a recording of the operation sound as detected by the microphone 21 of the reference device 20 to the observer devices 10. In such scenario, the recording of the detected sound may for example be used for recognizing the operation sound(s).

In some scenarios, the timing of the operation may be determined based on a signal provided to the tool, e.g., a control signal or a supply signal. An example of such scenarios is explained in connection with FIG. 4, where the reference device 20 generates the reference signal R based on the control signal C provided to the tool 100, 110, and the observer devices 10 determine the timing of the operation based on the reference signal R generated based on the control signal C.

In some scenarios, the timing of the operation may be determined based on optical monitoring of the tool. An example of such scenarios is explained in connection with FIG. 6, where the observer devices 10 utilize the optical sensors 12 to monitor the tool 100, 110 to determine the timing of the operation performed by the tool 100, 110.

At step 830, the timing of the at least one operation sound detected at step 810 is indicated to a device determination of the position of the tool. For example, this may involve that the above-mentioned observer devices 10 indicate the respectively determined timing of the detected operation sound to the above-mentioned locator device 30. Further, in the scenario of FIG. 2 this may involve that the reference device 20 indicates the timing of the operation sound as detected by the reference device 20 as reference timing to the observer devices 10. The indicated timing may then be used as input for determining the position of the tool, e.g., based on a TDOA method or a TOA method. The position of the tool may be determined in terms of a point of interaction of the tool with an object being processed by the tool. For example, in the scenario of FIG. 1A the determined position could be the position of the welding spot, and in the scenario of FIG. 1B the determined position could be the position of the hole being drilled. In some scenarios, the timing may be indicated in relation to the timing of the operation as determined at step 820. In this case, the timing of the operation may be used as a time reference, e.g., for calculating a propagation delay of the detected at least one operation sound.

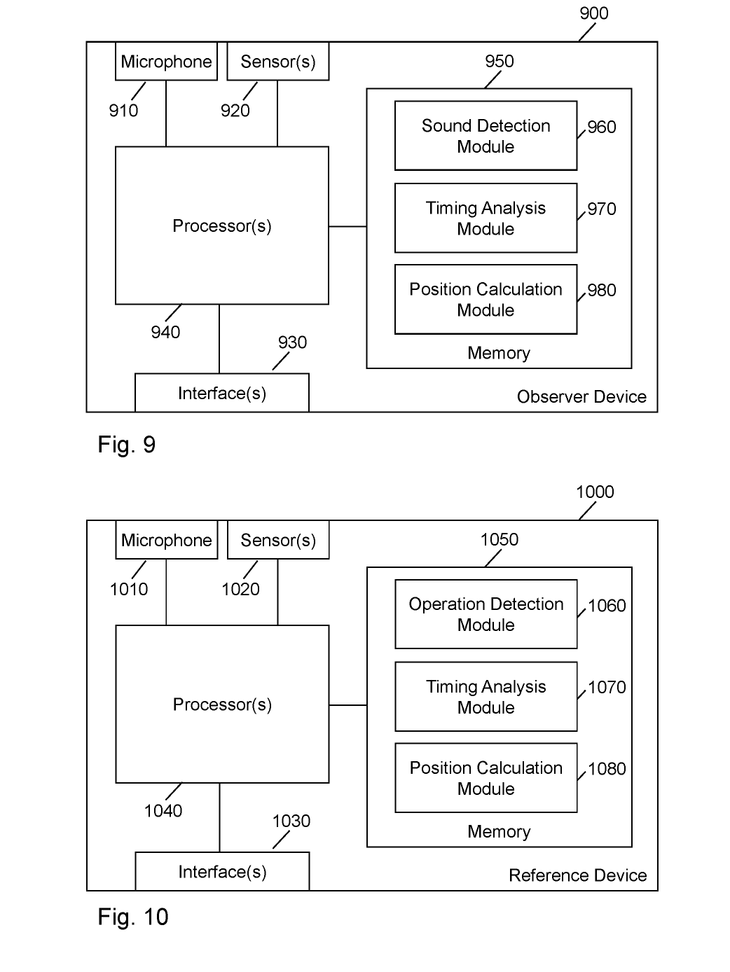

FIG. 9 shows a block diagram for schematically illustrating a processor based implementation of an observer device 900. The structures of the observer device 900 as illustrated in FIG. 9 may for example be used for implementing the above-mentioned observer devices 10.

As illustrated, the observer device 900 includes a microphone 910, e.g., corresponding to the above-mentioned microphone 11, which may be used for detecting the operation sound. The microphone 910 may for example be based on a MEMS (microelectromechanical system) technology, ECM (electret condenser microphone) technology, or piezo technology. Further, the observer device 900 may include one or more additional sensor(s) 920, e.g., an optical sensor. The additional sensor(s) may for example be used for the above-mentioned optical monitoring of the tool to determine the timing of the operation performed by the tool. Further, the observer device 900 may include one or more interfaces 930. The interface(s) 930 may for example be used for receiving the above-mentioned reference signal R, for indicating determined timings to other devices, e.g., to a separate locator device 30 to another observer device 10, for receiving determined timings from other observer devices 10.

As further illustrated, the observer device 900 is provided with one or more processors 940 and a memory 950. The microphone 910, the sensor(s) 920, the interface(s) 930, and the memory 950 are coupled to the processor(s) 940, e.g., using one or more internal bus systems of the observer device 900.

The memory 950 includes program code modules 960, 970 with program code to be executed by the processor(s) 940. As illustrated, these program code modules include a sound detection module 960, a timing analysis module 970, and a position calculation module 970.

The sound detection module 960 may implement the above-described functionalities of detecting the operation sound of the tool. The timing analysis module 970 may implement the above-described functionalities of determining a timing of the detected operation sound and/or determining the timing of the operation causing the detected operation sound. The position calculation module 980 may implement the above described functionalities of calculating the position of the tool based on the determined timings, e.g., using a TDOA method or a TOA method.

It is to be understood that the structures as illustrated in FIG. 9 are merely exemplary and that the observer device 900 may also include other elements which have not been illustrated, e.g., structures or program code modules for implementing known functionalities of a sound-based positioning device.

FIG. 10 shows a block diagram for schematically illustrating a processor based implementation of a reference device 1000. The structures of the observer device 900 as illustrated in FIG. 9 may for example be used for implementing the above-mentioned observer devices 10.

As illustrated, the reference device 1000 may include a microphone 1010, e.g., corresponding to the above-mentioned microphone 21, which may be used for detecting the operation sound. The microphone 1010 may be configured as a near-field microphone. The microphone 1010 may for example be based on a MEMS technology ECM technology, or piezo technology. Further, the reference device 1000 may include one or more additional sensor(s) 1020. The additional sensor(s) may for example be used for the above-mentioned optical monitoring of the tool to determine the timing of the operation performed by the tool. Further, the observer device reference device 1000 may include one or more interfaces 1030. The interface(s) 1030 may for example be used for sending the above-mentioned reference signal R, and/or for receiving determined timings from observer devices 10.

As further illustrated, the reference device 1000 is provided with one or more processors 1040 and a memory 1050. The microphone 1010, the sensor(s) 1020, the interface(s) 1030, and the memory 1050 are coupled to the processor(s) 1040, e.g., using one or more internal bus systems of the reference device 1000.

The memory 1050 includes program code modules 1060, 1070 with program code to be executed by the processor(s) 1040. As illustrated, these program code modules include a sound detection module 1060, a timing analysis module 1070, and a position calculation module 1070.

The sound detection module 1060 may implement the above-described functionalities of detecting the operation sound of the tool. The timing analysis module 1070 may implement the above-described functionalities of determining a timing of the detected operation sound and/or determining the timing of the operation causing the detected operation sound. The position calculation module 1080 may implement the above described functionalities of calculating the position of the tool based on the determined timings, e.g., using a TDOA method or a TOA method.

It is to be understood that the structures as illustrated in FIG. 10 are merely exemplary and that the observer device 1000 may also include other elements which have not been illustrated, e.g., structures or program code modules for implementing known functionalities of a sound-based positioning device.

As can be seen, the concepts according to embodiments as explained above allow for efficiently implementing sound-based position measurements for a tool, without requiring dedicated sound sources. Accordingly, the illustrated concepts can be implemented with low complexity hardware. Moreover, by using operation sounds intrinsically generated by the tool, background noise problems can be alleviated. Still further, by detecting operation sounds which are generated by interaction of the tool with an object which is being processed by the tool, it becomes possible to precisely detect the position where the tool interacts with an object.

It is to be understood that the concepts as explained above are susceptible to various modifications. For example, the concepts could be applied in connection with various kinds of tools which intrinsically produce sounds during operation, without limitation to the above-mentioned examples of tools. Moreover, it is noted that the illustrated concepts could be applied in connection with various kinds of sound processing techniques, including filtering, digital sampling, or the like. Further, it is noted that the functionalities of the illustrated devices could also be rearranged in various ways. For example, the functionalities of the locator device 30 may also be implemented in one or more of the observer devices 10 or in the reference device 20. Further, the functionalities of two or more observer devices 10 could also be combined in one observer device 10, by providing the observer device with multiple spatially separated sensors for detecting the operation sound.

1. A method of determining a position of a tool, the method comprising:
detecting at least one sound generated by an operation performed by the tool; and
based on a timing of the at least one sound that was detected, determining the position of the tool.

2. The method according to claim 1, further comprising:
determining a timing of the operation performed by the tool, and
determining the position based on the timing of the operation performed and the timing of the at least one sound that was detected.

3. The method according to claim 2, further comprising:
determining the timing of the operation based on a signal received from the tool.

4. The method according to claim 2, further comprising:
determining the timing of the operation based on a signal received from a reference device placed on the tool.

5. The method according to claim 4,
wherein the signal comprises a recording of the at least one sound that was detected.

6. The method according to any one of claims 24, further comprising:
determining the timing of the operation based on a signal provided to the tool.

7. The method according to any one of claims 2, further comprising:
determining the timing of the operation based on optical monitoring of the tool.

8. The method according to claim 1, further comprising:
detecting the at least one sound by multiple sensors placed at different locations; and
determining the position based on timings of the at least one sound by the multiple sensors.

9. The method according to claim 1, further comprising:
wherein the tool comprises a welding tool and the at least one sound comprises a sound generated by a welding operation performed by the welding tool, and/or
wherein the tool comprises a drilling tool and the at least one sound comprises a sound generated by a drilling operation performed by the drilling tool, and/or
wherein the tool comprises a cutting tool and the at least one sound comprises a sound generated by a cutting operation performed by the cutting tool, and/or
wherein the tool comprises a pneumatic actuator and the at least one sound comprises a sound generated by the pneumatic actuator when the tool performs the operation.

10. A method of supporting determination of a position of a tool, the method comprising:
detecting at least one sound generated by an operation performed by the tool; and
indicating a timing of the at least one sound that was detected to a device for determination of the position of the tool.

11. The method according to claim 10, further comprising:
indicating the timing of the at least one sound that was detected in relation to a timing of the operation performed by the tool.

12. The method according to claim 10,
wherein the tool comprises a welding tool and the at least one sound comprises a sound generated by a welding operation performed by the welding tool, and/or
wherein the tool comprises a drilling tool and the at least one sound comprises a sound generated by a drilling operation performed by the drilling tool, and/or
wherein the tool comprises a cutting tool and the at least one sound comprises a sound generated by a cutting operation performed by the cutting tool, and/or
wherein the tool comprises a pneumatic actuator and the at least one sound comprises a sound generated by the pneumatic actuator when the tool performs the operation.

13. A device for determining the position of a tool, the device being configured to perform operations comprising:
detecting at least one sound generated by an operation performed by the tool; and
based on a timing of the at least one sound that was detected, determining the position of the tool.

14. The device according to claim 13,
wherein the device is configured to perform a method according to claim 1.

15. A device for supporting determination of the position of a tool, the device being configured to perform operations comprising:
detecting at least one sound generated by an operation performed by the tool; and
indicating a timing of the at least one sound that was detected to a device for determination of the position of the tool.

16. The device according to claim 15,
wherein the device is configured to perform a method according to claim 1.

17. A system for determining the position of a tool, the system comprising:
one or more first devices configured to detect a timing of at least one sound generated by an operation performed by the tool; and
one or more second devices configured to detect a timing of the operation performed by the tool.

18. The system according to claim 17,
wherein at least one of the first devices is configured to perform a method according to claim 1.
